(19) United States
(12) Patent Application Publication
(10) Pub. No.: US 2014/0078177 A1
(43) Pub. Date: Mar. 20, 2014

(54) IMAGE SYNTHESIZING SYSTEM, IMAGE PROCESSING APPARATUS, AND IMAGE PROCESSING METHOD

(71) Applicant: FUJIFILM Corporation, Tokyo (JP)

(72) Inventors: Kei YAMAJI, Tokyo (JP); Takeshi TERAOKA, Tokyo (JP)

(73) Assignee: FUJIFILM Corporation, Tokyo (JP)

(21) Appl. No.: 13/967,746

(22) Filed: Aug. 15, 2013

(30) Foreign Application Priority Data
Sep. 14, 2012 (JP) 2012-203239
May 29, 2013 (JP) 2013-112712

(51) Int. Cl. G09G 5/14

(52) U.S. Cl. CPC G09G 5/14
USPC 345/634

(57) ABSTRACT

The image processing apparatus is adapted to create a synthetic image using a plurality of images stored in an image managing server, and comprises an image acquiring unit that acquires a plurality of images from the image managing server; and a synthetic image creating unit that creates the synthetic image using the acquired images according to a predetermined priority for creating the synthetic image.

### BACKGROUND OF THE INVENTION

The present invention relates to an image synthesizing system, an image processing apparatus, and an image processing method that can create a synthetic image such as a photo book or a collage print using users' images stored in a storage of a server providing a cloud service and that can provide the created synthetic image to users.

At present, a social networking service (SNS), an online storage service, and the like are known as cloud services in which users' images are stored in a storage of a server via a network such as the Internet.

The SNS is a community type web service intended for users to communicate with each other and has, for example, a function of allowing users to share and view (or, to publish) images, which have been uploaded to a server via a network by the users, and the like.

The online storage service is a service of lending a storage (disk space) of a server to users, where the users can upload or download images to and from the server via a network.

In the cloud service such as the SNS or the online storage service, a synthetic image such as a photo book or a collage print is created using users' images stored in the storage of the server and is provided to users.

Here, the photo book is a service of creating an image collection in which a predetermined number of images selected from the users' images are arranged in a predetermined layout in a predetermined number of pages.

The collage print is a service of creating a synthetic image in which a predetermined number of images selected from the users' images are arranged in a predetermined layout in a single print.

For example, JP 2009-265886 A, JP 2006-120076 A, JP 2004-70614 A, and JP 2004-246868 A are known as technical literatures in the art that are related to the present invention.

JP 2009-265886 A discloses an image managing apparatus for providing images to plural information processing apparatuses via a network, in which a behavior pattern to images which highly catches the fancy of a visitor is individually set for each visitor, an image of which the previous operation history of a visitor corresponds to the set behavior pattern of the visitor is retrieved from the images provided, and the retrieved image is displayed on a screen or book data including the retrieved image is individually created for each visitor.

JP 2006-120076 A discloses an image processing method of creating a photo album by adding the “extent of favorite” of a sorting person as a sorting key to each image, sorting plural images belonging to the same category, setting pages of a photo album using predetermined plural photo-album templates, and extracting and arranging photographs to be arranged in the set album on the basis of the added “extent of favorite”.

JP 2004-70614 A discloses a method of controlling an image processing server connected to plural terminals via communication lines, in which at least one image group including images received from a terminal is stored, vote information correlated with a specific image in a specific image group out of the images received from the terminal is counted and stored, and display information to be displayed on the terminal or other terminals accessible to the image processing server is created on the basis of the counting result of the vote information.

JP 2004-246868 A discloses an image extracting method of extracting a predetermined number of images out of plural images, in which a photo album is created by sequentially inputting the “extent of favorite” as a user's evaluation value on an image for the plural images, extracting a predetermined number of images out of the plural images on the basis of the input “extents of favorite”, and arranging the extracted images in each page of the photo album.

JP 2009-265886 A, JP 2006-120076 A, JP 2004-70614 A, and JP 2004-246868 A each describe that a predetermined number of images are selected from plural images on the basis of the extent of favorite and the selected images are displayed or a photo book is created using the selected images.

In the cloud service such as the SNS or the online storage service, a user views a synthetic image such as a photo book or a collage print displayed in a web site and determines whether to order the synthetic image or not. Accordingly, for example, when an image is uploaded or an uploaded image is edited, it is necessary to create and display a synthetic image in a short time.

### SUMMARY OF THE INVENTION

An object of the present invention is to provide an image synthesizing system, an image processing apparatus, and an image processing method that can reduce the time taken for a synthetic image such as a photo book or a collage print to be presented to a user.

In order to attain the object described above, the present invention provides an image processing apparatus that creates a synthetic image using a plurality of images stored in an image managing server, comprising:

an image acquiring unit that acquires a plurality of images from the image managing server; and

a synthetic image creating unit that creates the synthetic image using the acquired images according to a predetermined priority for creating the synthetic image.

Also, the present invention provides an image processing method of creating a synthetic image using a plurality of images stored in an image managing server, comprising the steps of:

acquiring a plurality of images from the image managing server; and

creating the synthetic image using the acquired images according to a predetermined priority for creating the synthetic image.

Also, the present invention provides an image synthesizing system comprising:

an image managing server; and

the image processing apparatus according to claim 1 that creates a synthetic image using a plurality of images stored in the image managing server.

According to the present invention, it is possible to reduce the time taken for a synthetic image such as a photo book or a collage print to be presented to a user by creating a synthetic image according to a predetermined priority for creating the synthetic image.

### BRIEF DESCRIPTION OF THE DRAWINGS

FIG. 1 is a conceptual diagram of an embodiment illustrating a configuration of an image synthesizing system according to the present invention.

FIG. 2 is a block diagram of a first embodiment illustrating a configuration of an image processing server.

FIG. 3 is a block diagram of a second embodiment illustrating the configuration of the image processing server.

FIG. 4 is a block diagram illustrating a configuration of a synthetic image creating unit.

FIG. 5 is a conceptual diagram illustrating a state where images of an online album are grouped into plural groups.

FIG. 6 is a conceptual diagram illustrating a state where a group including images having operation information added thereto is selected from plural groups.

FIG. 7 is a conceptual diagram illustrating a state where a first additional group is selected from groups of the same date as a selected group.

FIG. 8 is a conceptual diagram illustrating a state where a second additional group is selected from groups of a date closest to the date of a selected group.

FIG. 9 is a conceptual diagram illustrating Group 1 of which the number of images is 15 and which includes 10 images having operation information added thereto and Group 2 of which the number of images is 20 as the largest number of images and which includes a single image having operation information added thereto.

FIG. 10 is a conceptual diagram illustrating a state where 20 images in Group 2 including the largest number of images are grouped into two groups of 10 images.

FIG. 11 is a conceptual diagram illustrating a state where 15 images in Group 1 including the largest number of images having operation information added thereto are grouped into two groups of 8 images and 7 images.

FIG. 12 is a conceptual diagram illustrating an image analysis processing which is performed by an image analyzing unit.

### DETAILED DESCRIPTION OF THE INVENTION

Hereinafter, an image synthesizing system, an image processing apparatus, and an image processing method according to the present invention will be described in detail with reference to preferred embodiments shown in the accompanying drawings.

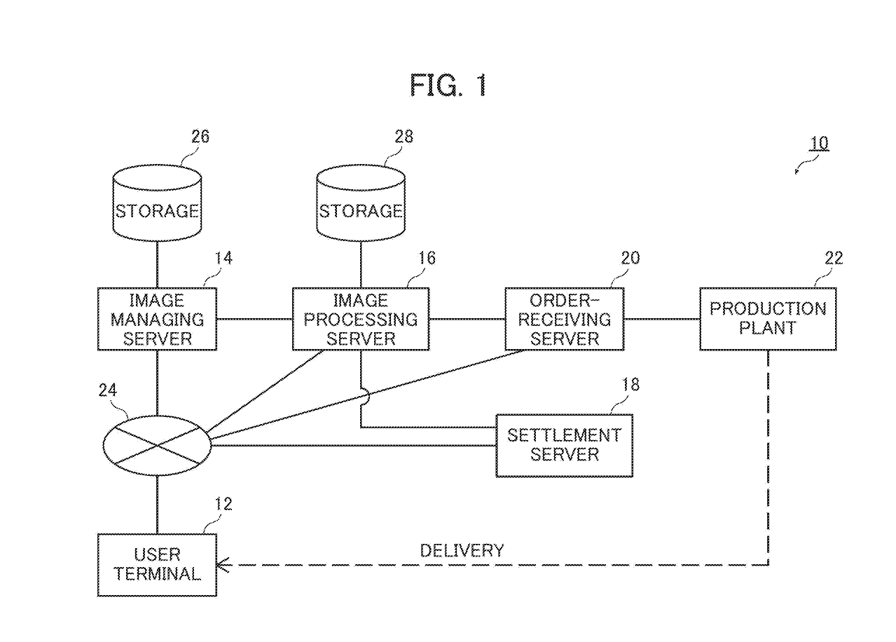

FIG. 1 is a conceptual diagram of an embodiment illustrating a configuration of an image synthesizing system according to the present invention. The image synthesizing system 10 illustrated in the drawing is a system that automatically creates and provides a synthetic image such as a photo book or a collage print to a user using images uploaded to a server by a user in cooperation with a cloud service such as an SNS or an online storage service and that sells and settles an account for the created synthetic image as a virtual product or a real product in cooperation with an online settlement system or an online order-receiving system.

Here, the virtual product is image data (digital data) of a synthetic image such as a photo book or a collage print created using image data (digital data) of plural images. The virtual product is downloaded and sold via a network 24 such as the Internet, or the virtual product is recorded on a recording medium such as a CD or a DVD in a production plant 22 and the recording medium is delivered to a user.

On the other hand, the real product is a synthetic image such as a photo book or a collage print as a real object created on the basis of image data of a virtual product. The real product is produced in the production plant 22 and is delivered to a user.

The virtual product and the real product are not limited to a charged product but include a charge-free product.

As shown in FIG. 1, the image synthesizing system 10 includes a user terminal 12, an image managing server 14, an image processing server 16 which is an embodiment of the image processing apparatus according to the present invention, a settlement server 18, and an order-receiving server 20.

The user terminal 12 is used by a user to upload images (for example, photographs) possessed by the user to the image managing server 14 via the network 24 from the user terminal 12, download an image uploaded to the image managing server 14 or a synthetic image created by the image processing server 16 to the user terminal 12 via the network 24, view an image or a synthetic image, and order a virtual product or a real product.

The user terminal 12 is, for example, a mobile terminal such as a mobile phone or a smartphone, a desktop PC (Personal Computer), a notebook PC, or a tablet PC.

In the illustrated example, only the single user terminal 12 is illustrated in order to avoid complexity of the drawing, but plural user terminals 12 possessed by users using the image synthesizing system 10 are provided in practice.

The image managing server 14 functions to provide a cloud service such as an SNS or an online storage service to a user via the network 24 and includes a storage 26.

The image managing server 14 stores and manages images uploaded from the user terminal 12 via the network 24 in the storage 26, and provides images stored in the storage 26 or a synthetic image such as a photo hook or a collage print acquired from the image processing server 16 to the user terminal 12 via the network 24.

It is not essential that the image managing server 14 provides the cloud service.

In addition, the image managing server 14 can store plural images in various image storage formats such as an album format (folder format) such as an online album, a storage format by date, and other storage formats.

In this embodiment, a case in which the image synthesizing system 10 cooperates with the image managing server 14 of the SNS is called SNS type, and a case in which the image synthesizing system 10 cooperates with the image managing server 14 of the online storage service is called storage type.

The cloud service is not limited to the SNS or the online storage service, but may include various services of uploading users' images to the image managing server 14 via the network 24 and storing the uploaded images in the storage 26.

The image processing server 16 functions to create a synthetic image (image data thereof) such as a photo book or a collage print using the images stored in the storage 26 of the image managing server 14 and includes a storage 28.

In this embodiment, the image processing server 16 creates a synthetic image for each online album stored in the storage 26 of the image managing server 14 and stores the created synthetic images in the storage 28.

In addition, the image processing server 16 receives an order for a virtual product or a real product from a user from the user terminal 12, and manages expiration dates of the synthetic images stored in the storage 28.

Details of the image processing server 16 will be described later.

The settlement server 18 functions to perform a settlement processing in response to a user's order online. An existing online settlement system can be used as the settlement server 18.

The order-receiving server 20 functions to perform an order-receiving processing in response to a user's order online. An existing online order receiving system can be used as the order-receiving server 20.

Details of the image processing server 16 will be described below.

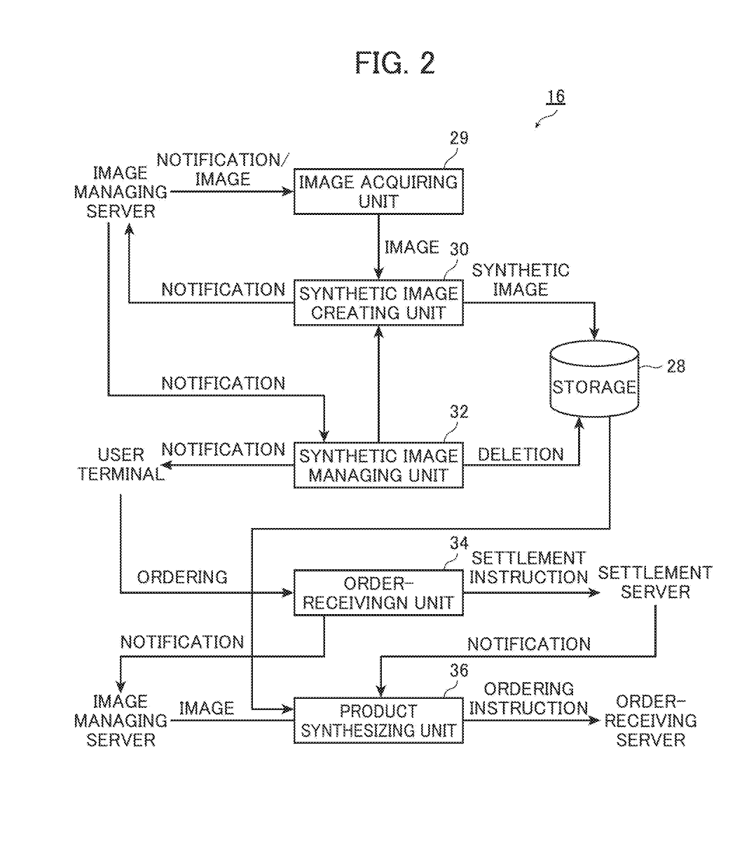

FIG. 2 is a block diagram of a first embodiment illustrating the configuration of the image processing server. The image processing server 16 illustrated in the drawing is of an SNS type and includes an image acquiring unit 29, a synthetic image creating unit 30, a synthetic image managing unit 32, an order-receiving unit 34, and a product synthesizing unit 36.

The SNS has a feature in which images are very frequently uploaded so as for a user to allow other users to view the images (to share the images with other users). A set of images uploaded in a certain period of time by a user is called an online album. When a new image is uploaded or an uploaded image is changed, the SNS type image synthesizing system 10 creates a synthetic image by online album in real time and provides the created synthetic image to the user terminal 12.

When a user uploads a new image to the image managing server 14 or adds, deletes, or edits an image in an online album stored in the storage 26 of the image managing server 14, the image acquiring unit 29 receives a notification of image change from the image managing server 14 and acquires images included in the online album in question from the storage 26 of the image managing server 14.

The synthetic image creating unit 30 functions to create a synthetic image such as a photo book or a collage print for each online album including the changed images in real time using the acquired images.

For each online album including the changed images, the synthetic image creating unit 30 acquires all the images included in the online album from the storage 26 of the image managing server 14. The synthetic image creating unit 30 analyzes and evaluates the respective acquired images, selects plural images used for a synthetic image on the basis of their evaluation values, and lays out the selected images to create the synthetic image. When the creation of the synthetic image ends, the synthetic image creating unit 30 stores the created synthetic image in the storage 28 and notifies the image managing server 14 of the end of creation of the synthetic image.

When a user deletes all the images included in an online album, the synthetic image creating unit 30 deletes the synthetic image corresponding to the online album.

Details of the synthetic image creating unit 30 will be described later.

The synthetic image managing unit 32 functions to manage synthetic images stored in the storage 28.

The synthetic image managing unit 32 manages the expiration dates of the synthetic images. When it is assumed that a synthetic image which has not been ordered even in a certain period of time, for example, two weeks, after the synthetic image is stored in the storage 28 is deleted from the storage 28, the synthetic image managing unit 32 notifies the user terminal 12 of a reminder indicating the date and time at which the synthetic image is deleted from the storage 28, for example, using a notification function of the SNS or an e-mail, just before the expiration date of the synthetic image.

In addition, the synthetic image managing unit 32 deletes the expired synthetic image through a batch processing, for example, in the night in which the load of the image processing server 16 is low, and notifies the user terminal 12 of deletion of the expired synthetic image.

When there is an album including an image violating public order and morality and it is assumed that an operator of the image managing server 14 deletes the image in question and notifies the image processing server 16 of the deletion, the synthetic image managing unit 32 manages the synthetic image creating unit 30 so that the unit 30 may newly create a synthetic image, and collects and manages statistical information on how many synthetic images each user created, how many products each user purchased, and the like, on the basis of the notification of the deletion of the image violating public order and morality.

The order-receiving unit 34 receives a user's order for a virtual product or a real product from the user terminal 12.

The order-receiving unit 34 displays a screen for inputting settlement information on a display of the user terminal 12, acquires settlement information such as ordering information indicating a virtual product or a real product ordered by the user and the number of the product; payment information such as credit card payment, cash on delivery, and bank transfer; delivery information indicating a transport company used for delivery of the ordered product; and user information such as a user address, a user name, and a phone number, and notifies the settlement server 18 of the acquired settlement information and an instruction of settlement.

The order-receiving unit 34 notifies the image managing server 14 of the end of ordering when the ordering ends.

When the notification of the end of settlement is received from the settlement server 18, the product synthesizing unit 36 synthesizes a virtual or real product (image data thereof) ordered by the user using images included in an online album ordered by the user and image data of a synthetic image of the online album.

In this embodiment, when an image is uploaded from the user terminal 12 to the image managing server 14, the image managing server 14 creates plural images having different resolutions, for example, images having five different resolutions, from the uploaded image and stores the created images in the storage 26.

In the case of a virtual product, since a virtual product only needs to be viewed on the screen of the user terminal 12, the product synthesizing unit 36 performs a synthesis processing of outputting an image of 800×600 pixels, for example, using images of 640×480 pixels as the input.

On the other hand, in the case of a real product subjected to silver-halide printing, the product synthesizing unit 36 performs an image correction processing, for example, using an image correcting tool and then performs a synthesis processing of outputting an image of 3000×2000 pixels having a high resolution as compared with the case of a virtual product using images of 1024×768 pixels having a high resolution as compared with the case of a virtual product as the input.

The product synthesizing unit 36 notifies the order-receiving server 20 of image data of the synthesized virtual product or real product, settlement information, and an instruction of ordering.

Next, the operation of the SNS type image synthesizing system 10 shown in FIGS. 1 and 2 will be described below.

First, a user uploads one or more images (image data thereof) from the user terminal 12 to the image managing server 14 via the network 24.

The image managing server 14 receives a series of images uploaded in a certain period of time from the user terminal 12, stores the received images as an online album in the storage 26, and notifies the image processing server 16 of change of images in the storage 26.

When the uploaded images are stored in the storage 26 of the image managing server 14, a user can any time view the images included in an online album using the user terminal 12 for each online album.

In the SNS web site, for example, thumbnail images of representative images of the online albums are displayed as a list of online albums uploaded by the user.

When a user clicks one online album in the list of online albums with an input device such as a mouse, thumbnail images of the respective images are displayed as a list of images included in the clicked online album.

Subsequently, in the image processing server 16, when the notification of change of images is received from the image managing server 14, the synthetic image creating unit 30 creates a synthetic image such as a photo book or a collage print in real time using the images included in an online album for each online album newly uploaded. The synthetic image creating unit 30 stores the created synthetic image in the storage 28 and notifies the image managing server 14 of the end of creation of the synthetic image.

Subsequently, when the notification of the end of creation of the synthetic image is received from the image processing server 16, the image managing server 14 notifies the user terminal 12 of the notification, for example, using a news-feed function of the SNS.

When a user clicks a news corresponding to the notification of the end of creation of the synthetic image in a list of news feeds displayed on the display of the user terminal 12 using an input device such as a mouse, the image managing server 14 acquires the synthetic image corresponding to the notification of the end of creation of the synthetic image from the storage 28 of the image processing server 16 and displays the acquired synthetic image on the display of the user terminal 12.

That is, when images are uploaded by a user, the user can view the synthetic image such as a photo book or a collage print created using the images included in an online album in real time for each online album.

In the SNS, it is possible to set a range to which the images uploaded to the image managing server 14 are published (to set users sharing the images). Similarly, as for the synthetic image, it is possible to set a range to which the synthetic image is published, and the synthetic image can be published to (shared among) users.

A user can do addition of a new image to an online album, edition such as deletion, rotation, and correction (color adjustment, trimming, and the like) of an existing image included in the online album, change of a cover image of a photo album, change of the title or explanatory text of the online album, and the like.

For example, when a user changes images stored in an online album in the storage 26, the image managing server 14 notifies the image processing server 16 of the change of images in the storage 26.

Here, the notification of the change of images includes not only the change of images, but also the change of a cover image of the photo album, the change of the title or explanatory text of the online album, and the like.

In the image processing server 16, when the notification of the change of images is received from the image managing server 14, the synthetic image creating unit 30 creates a synthetic image in real time again for each online album including the changed images. The synthetic image creating unit 30 stores the re-created synthetic image in the storage 28 and notifies the image managing server 14 of the end of re-creation of the synthetic image.

The subsequent operation of the image managing server 14 is the same as described above.

That is, when an image included in an online album is changed, a synthetic image corresponding to the changed image is created again in real time and is displayed on the display of the user terminal 12.

When a synthetic image is re-created for every edition of an image by a user, the load of the server becomes excessively large. Therefore, it is preferable that the synthetic image creating unit 30 creates a synthetic image again at a timing at which the user clicks a synthetic image update button displayed at the same time as an image edition screen is displayed on the display of the user terminal 12 using an input device such as a mouse, for example, in a step in which the operation of editing all images ends, instead of automatically re-creating a synthetic image.

In this case, a user can display an updated synthetic image by pushing the synthetic image update button at the timing at which the user wants to re-create a synthetic image. When the user does not want to display the updated synthetic image, the user does not need to push the update button.

On the other hand, as a back-end processing, the synthetic image creating unit 30 may automatically update the synthetic image not reflecting the newest state of the online album to a synthetic image reflecting the newest state of the online album when the load of the server is low, such as in the night.

Furthermore, it is preferable that when the operator of the image managing server 14 notifies the image processing server 16 of deletion of an image violating public order and morality, the synthetic image creating unit 30 update the synthetic image of the online album which included the deleted image.

In the image processing server 16, the synthetic image managing unit 32 notifies the user terminal 12 of a reminder indicating the date and time at which a synthetic image just before the expiration date thereof would be deleted from the storage 28.

When the reminder indicating that the expiration date is near is received from the image processing server 16, the user determines whether or not to order the virtual product or the real product of the online album just before the expiration date thereof. Then, the user can order the virtual product or the real product of the online album in display by clicking an ordering button displayed at the same time as the synthetic image is displayed on the display of the user terminal 12 using an input device such as a mouse.

Here, when a synthetic image reflecting the newest state of the online album is created at the time of editing images in the online album, the re-creation of the synthetic image is not performed at the time of ordering and the synthetic image updated during the edition is displayed as the synthetic image for confirmation of order on the display of the user terminal 12.

On the other hand, when a user has not clicked the synthetic image update button after editing the images in the online album, that is, when the newest state of the online album has not been reflected in the synthetic image, re-creation of the synthetic image is performed at the time of ordering and the synthetic image updated at the time of ordering is displayed as a synthetic image for confirmation of order on the display of the user terminal 12.

Subsequently, when the user clicks an ordering button displayed on the display of the user terminal 12 using a mouse or the like, the order-receiving unit 34 in the image processing server 16 displays a screen for inputting settlement information on the display of the user terminal 12, and acquires the settlement information including ordering information, payment information, delivery information, user information, and the like. Then, when the user clicks a decision button for final order, the order-receiving unit 34 transmits the acquired settlement information and the instruction of settlement to the settlement server 18 and notifies the image managing server 14 of the end of ordering.

The image managing server 14 receives the notification of the end of ordering from the image processing server 16 and manages the ordering history. The user can any time view the ordering history on the display screen of the user terminal 12.

When the settlement information and the instruction of settlement are received from the image processing server 16, the settlement server 18 performs a settlement processing on the user's order using the settlement information. That is, payment of purchase money for a product in response to the user's ordering is performed online from the settlement server 18 to the order-receiving server 20. When the settlement processing ends, the settlement server 18 notifies the image processing server 16 of the end of the settlement processing.

Subsequently, when the notification of the end of the settlement processing is received from the settlement server 18, the product synthesizing unit 36 of the image processing server 16 synthesizes the virtual product or the real product ordered by the user.

The product synthesizing unit 36 notifies the order-receiving server 20 of the image data of the synthesized virtual product or real product, the settlement information, and the instruction of ordering.

When the notification of the image data of the synthesized virtual product or real product, the settlement information, and the instruction of ordering is received from the image processing server 16, the order-receiving server 20 performs an order-receiving processing for the user's ordering. Using the settlement information, the order-receiving server 20 displays a screen for downloading the virtual product on the display of the user terminal 12 or requests the production plant 22 to produce a CD or a DVD storing the image data of the virtual product or to produce the real product.

In addition, payment of production cost for the product ordered by the user is performed online from the order-receiving server 20 to the production plant 22, and payment of the royalty for the user's ordering is performed online from the order-receiving server 20 to the image managing server 14.

When the request for producing the virtual product or the real product is received from the order-receiving server 20, the production plant 22 produces a product on the basis of the image data of the virtual product or the real product and the settlement information and delivers the produced product to the user using a designated transport company.

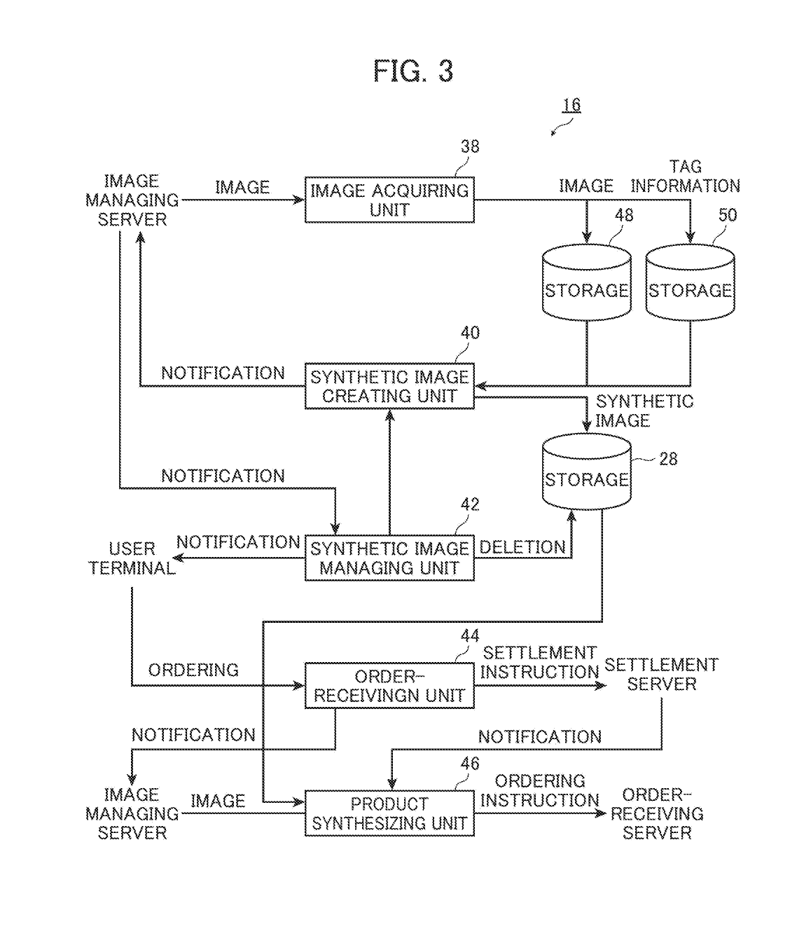

Next, FIG. 3 is a block diagram of a second embodiment illustrating the configuration of the image processing server. The image processing server 16 illustrated in the drawing is of a storage type and includes an image acquiring unit 38, a synthetic image creating unit 40, a synthetic image managing unit 42, an order-receiving unit 44, and a product synthesizing unit 46.

In the online storage, a user uploads images, for example, for the purpose of backup. In the storage type image synthesizing system 10, images are classified (grouped) on the basis of various conditions such as date, subject, and event such as summer vacation in accordance with tag information of Exif or the like attached to the images (collateral information). Images are accumulated and at a time point at which images in a certain class reach a predetermined number, for example, 30 or more, a synthetic image is created and provided to the user terminal 12 in accordance with the classification.

The image acquiring unit 38 functions to periodically perform a synchronous processing of acquiring images stored in the storage 26 of the image managing server 14, for example, once every three days, and includes storages 48 and 50.

The image acquiring unit 38 acquires images from the storage 26 of the image managing server 14, optionally changes resolutions of the images, and stores the images in the storage 48. Also, the image acquiring unit 38 extracts tag information from the acquired images, and stores the extracted tag information in the storage 50.

The tag information is attached to each image. In addition to tag information such as the shooting date and time of an image, the image size, and the type of an image shooting device which are automatically attached to the image by an image shooting device, the user can input arbitrary tag information using an input device such as a keyboard. For example, the arbitrary tag information includes event information such as birthday, sports day, and the like, person information such as family, friends, and the like, and favorite information indicating an image preferred by the user. The image acquiring unit 38 may acquire all images again for each synchronous processing, but in consideration of the load of the synchronous processing, it is preferable that only the images which are changed after the previous synchronous processing be acquired.

Similarly to the synthetic image creating unit 30 of the SNS type image processing server 16, the synthetic image creating unit 40 creates a synthetic image for each online album of which the tag information stored in the storage 50 satisfies a predetermined condition using the images included in the online album stored in the storage 48.

For example, the synthetic image creating unit 40 creates a synthetic image of an online album including birthday images or creates a synthetic image of an online album including family images, on the basis of the tag information.

The synthetic image managing unit 42, the order-receiving unit 44, and the product synthesizing unit 46 are the same as the synthetic image managing unit 32, the order-receiving unit 34, and the product synthesizing unit 36 of the SNS type image processing server 16, respectively.

Next, the operation of the storage type image synthesizing system 10 shown in FIGS. 1 and 3 will be described below.

A user uploads one or more images (image data thereof) from the user terminal 12 to the image managing server 14 via the network 24.

The image managing server 14 receives a series of images which are uploaded in a certain period of time from the user terminal 12 and stores the received images as an online album in the storage 26.

In the image processing server 16, the image acquiring unit 38 performs a synchronous processing of periodically acquiring the images stored in the storage 26 of the image managing server 14 and stores images and tag information in the storages 48 and 50, respectively, for each online album.

The synthetic image creating unit 40 creates a synthetic image for each online album of which the tag information satisfies a predetermined condition using the images included in the online album stored in the storage 48. Then, the synthetic image creating unit 40 stores the created synthetic image in the storage 28 and notifies the image managing server 14 of the end of creation of the synthetic image.

When the notification of the end of creation of the synthetic image from the image processing server 16 is received, the image managing server 14 notifies the user terminal 12 of the notification, for example, using an e-mail.

When the user clicks (selects) a link to the synthetic image described in the e-mail using an input device such as a mouse, the image managing server 14 acquires the synthetic image from the storage 28 of the image processing server 16 and displays the acquires synthetic image on the display of the user terminal 12.

The subsequent operation is the same as in the SNS type image synthesizing system 10.

Next, details of the synthetic image creating unit 30 will be described below.

The same is true of the synthetic image creating unit 40.

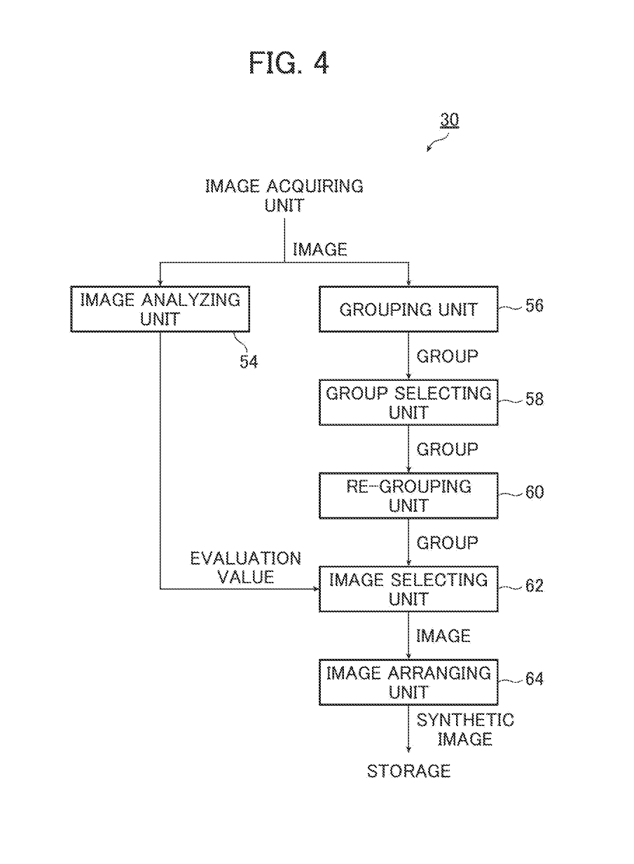

FIG. 4 is a block diagram illustrating the configuration of the synthetic image creating unit. The synthetic image creating unit 30 illustrated in the drawing includes an image analyzing unit 54, a grouping unit 56, a group selecting unit 58, a re-grouping unit 60, an image selecting unit 62, and an image arranging unit 64.

In the synthetic image creating unit 30, the image analyzing unit 54 analyzes each of images included in the online album acquired by the image acquiring unit 29 to determine the evaluation values thereof.

Details of the image analyzing unit 54 will be described later.

The grouping unit 56 groups plural images in the online album acquired by the image acquiring unit 29 into plural groups on the basis of collateral information of the respective acquired images.

When shooting date and time is used as the collateral information, the grouping unit 56 groups the plural images in the acquired online album into plural groups so that two images with a relatively long shooting time interval between them may be included in different groups.

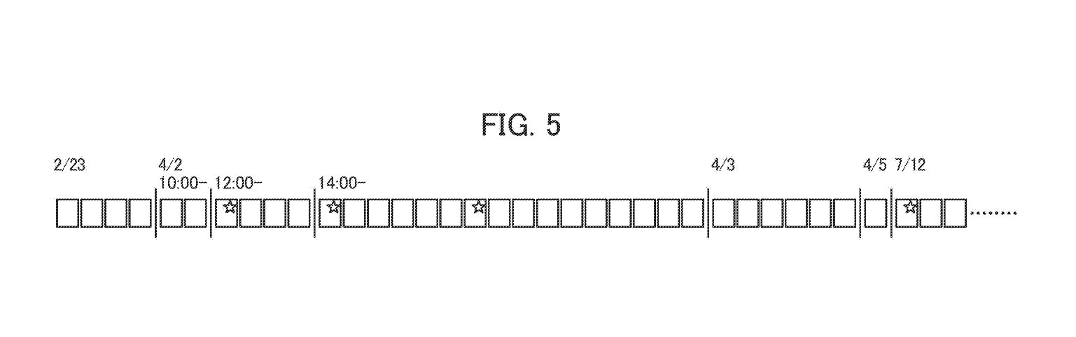

In the example illustrated in FIG. 5, plural images are grouped into a group shot on February 23, a group shot on April 2 at or after 10:00, a group shot on the same day at or after 12:00, a group shot on the same day at or after 14:00, a group shot on April 3, a group shot on April 5, a group shot on July 12, . . . , on the basis of the shooting date and time.

When the shooting location is used as the collateral information, the grouping unit 56 groups plural images into plural groups according to the shooting location. The images may be grouped using the collateral information other than the shooting date and time or the shooting location.

Subsequently, the group selecting unit 58 selects, from among the plural groups, a predetermined number of groups including the images to which operation information on operations performed by the user on each of the images is added as the collateral information of each of the images.

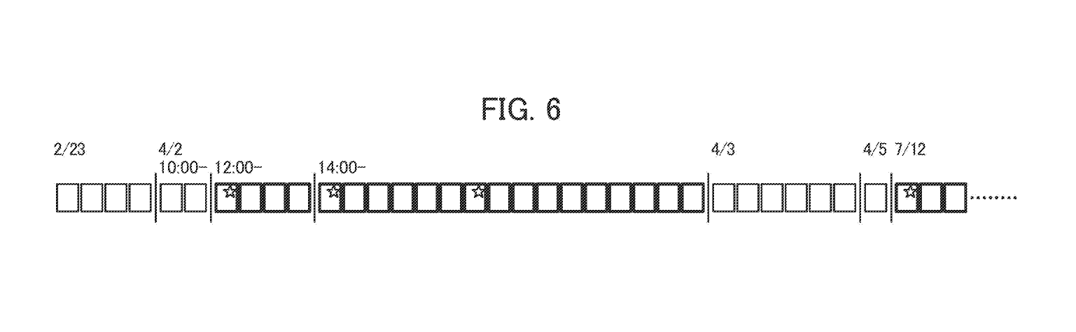

In the example illustrated in FIG. 6, the group shot on April 2 at or after 12:00, the group shot on the same day at or after 14:00, the group shot on July 12, . . . (groups including images shown with bold frames) are selected. In the drawing, images having a star mark are images having the operation information added thereto as the collateral information.

Here, examples of the operation information include added information such as “like” (favorite information) and “comment” added to the images by the user, evaluation information such as 5-step importance levels added to the images by the user, tag information added to the images by the user, and edition information performed on the images by the user.

The added information of “like” is added to a favorite image of the user in the SNS, for example, if the user clicks a button “like” displayed in correlation with the image in the web page having the image displayed therein using an input device such as a mouse. Similarly, the added information of “comment” is added to an image in the SNS, for example, on which the user wants to write a comment, if the user writes a comment in a comment input box displayed in correlation with the image in the web page having the image displayed therein using an input device such as a keyboard.

Here, when the number of images included in all the selected groups is equal to or more than a recommended number of images, the group selecting unit 58 ends the processing.

For example, a photo book of 16 pages can be created using 16 images, but one image is arranged in one page in this case, which causes poor attractiveness. Therefore, in order to enhance the attractiveness of the photo book (in order to arrange plural images in one page), the number of images to be recommended (the recommended number of images) is defined. For example, when four images are arranged in each page, the recommended number of images is 4 images×16 pages=64.

On the other hand, when the number of images included in all the selected groups is less than the recommended number of images, the group selecting unit 58 selects a predetermined number of first additional groups out of the groups (groups not having operation information added thereto) of the same date as the selected groups.

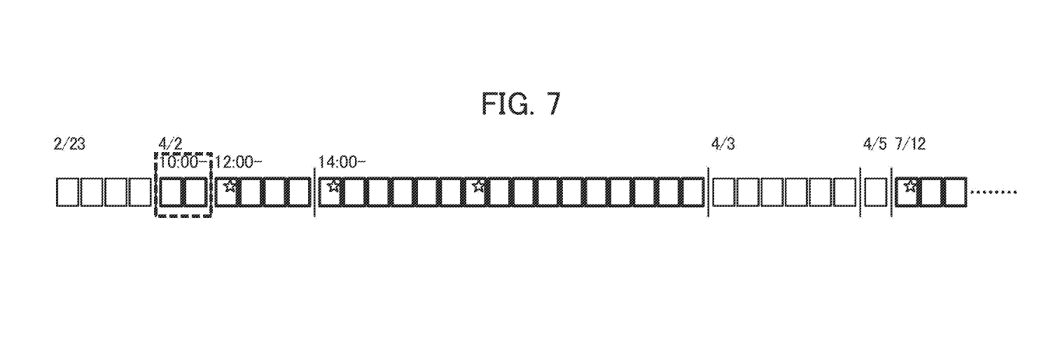

In the example illustrated in FIG. 7, the group shot at or after 10:00 (as surrounded with dotted lines) is selected from among the three groups shot on April 2 which are the same group as the group selected first. The first additional group may be selected out of the groups of the same date as another selected group, such as the group shot on July 12.

Here, when the number of images included in all the groups including the first additional group that are selected hitherto is equal to or more than the recommended number of images, the group selecting unit 58 ends the processing.

On the other hand, when the number of images included in all the groups including the first additional group that are selected hitherto is less than the recommended number of images, the group selecting unit 58 selects a predetermined number of second additional groups out of the groups (groups not having operation information added thereto) closest in date (shooting date and time) to the selected groups.

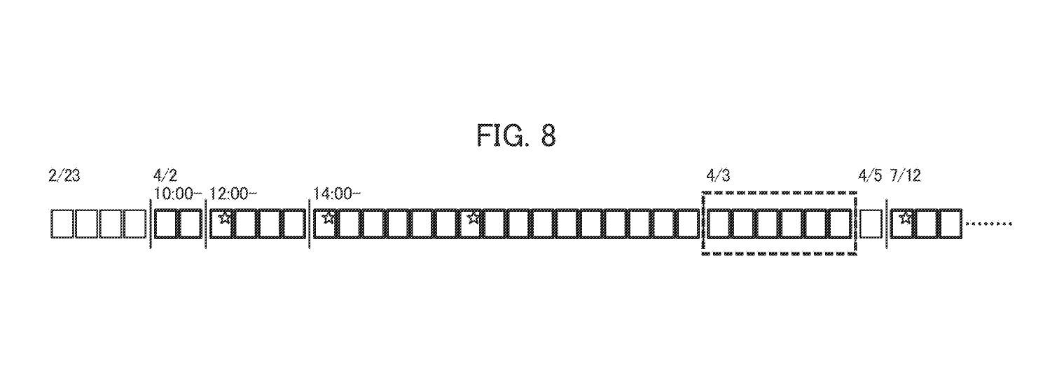

In the example illustrated in FIG. 8, the group shot on April 3 (as surrounded with dotted lines) which is closest in date to the selected groups shot on April 2 is selected. Similarly, the second additional group may be selected out of the groups of a date which is closest to that of another selected group, such as the group shot on July 12.

When the number of images included in all the groups including the first and second additional groups that are selected hitherto is equal to or more than the recommended number of images, the group selecting unit 58 ends the processing.

On the other hand, when the number of images included in all the groups including the first and second additional groups that are selected hitherto is less than the recommended number of images, the group selecting unit 58 selects a predetermined number of third additional groups out of the groups (groups not having operation information added thereto) second closest in date to the selected groups. Hereafter, an additional group is repeatedly selected until the number of images included in all the groups including the first to third additional groups that are selected hitherto is equal to or more than the recommended number of images if the former is less than the latter.

Subsequently, the re-grouping unit 60 re-groups a given number of selected groups depending on the number of pages of the photo book. For example, when the number of pages of the photo book is 10, the re-grouping unit 60 re-groups the selected groups into 10 groups.

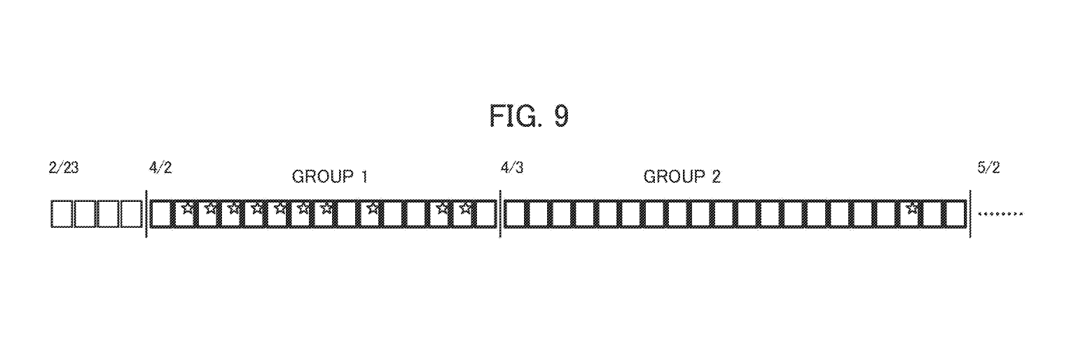

For example, as illustrated in FIG. 9, it is assumed that the number of images in Group 1 (a group including the largest number of images having operation information added thereto) is 15, the number of images having operation information added thereto in Group 1 is 10, the number of images in Group 2 (a group including the largest number of images) is 20, and the number of images having operation information added thereto in Group 2 is 1.

Group 1 including a large number of images having operation information added thereto is a group important to the user, and the images in Group 1, even those having no operation information added thereto, are higher in importance level than the images of other groups.

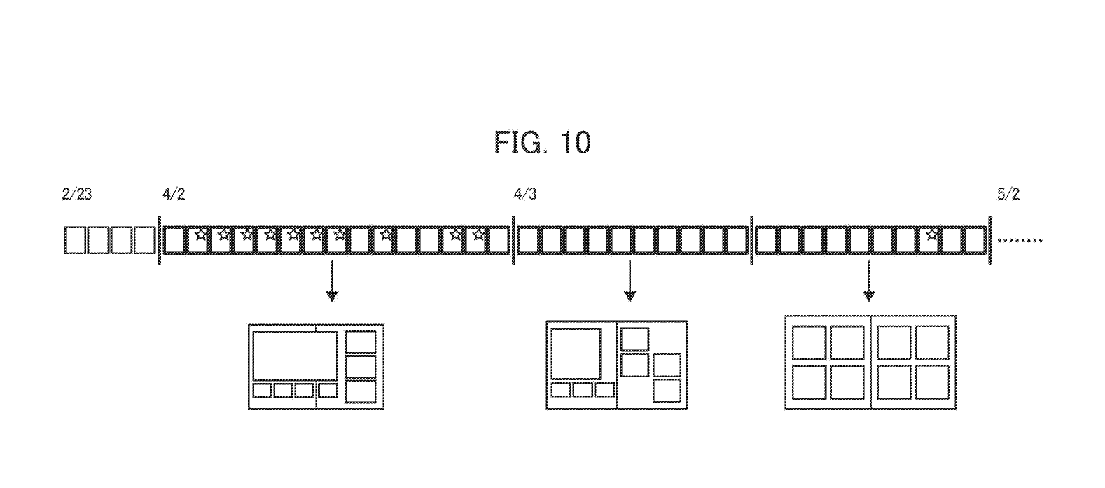

Therefore, as illustrated in FIG. 10, when 20 images in Group 2 including the largest number of images are grouped into two groups each including 10 images, the images of Group 1 which includes a large number of images having operation information added thereto and having higher importance levels are crowded into one page of the photo book. In the example illustrated in the drawing, when the number of images having operation information added thereto in Group 1 is 10 and the number of images to be arranged in one page of the photo book is 8, there may be images in Group 1 which are not used in the photo book, even if the images have operation information added thereto.

Therefore, when the number of pages of the photo book is larger than the number of selected groups, the re-grouping unit 60 performs a re-dividing processing to divide the images of the group in which the number of images having operation information added thereto is larger than the maximum number of images to be arranged in one page of the photo book into two groups between images having the longest shooting time interval between them.

It is preferable that the re-dividing processing be repeatedly performed until the number of images having operation information added thereto in a group obtained by the re-dividing processing is equal to or less than the maximum number of images to be arranged in one page of the photo book.

In addition, when there is no group in which the number of images having operation information added thereto is more than the maximum number of images to be arranged in one page of the photo book, the images of the group which includes the largest number of images are divided into two groups between images having the longest shooting time interval between them.

On the other hand, when the number of pages of the photo book is less than the number of selected groups, the re-grouping unit 60 performs a re-coupling processing to couple two groups having the shortest shooting time interval between them into one group.

Here, when the number of images having operation information added thereto in the group obtained by the re-coupling processing becomes more than the maximum number of images to be arranged in one page of the photo book, the re-coupling processing is not performed and two groups having the second shortest shooting time interval between them are coupled into one group.

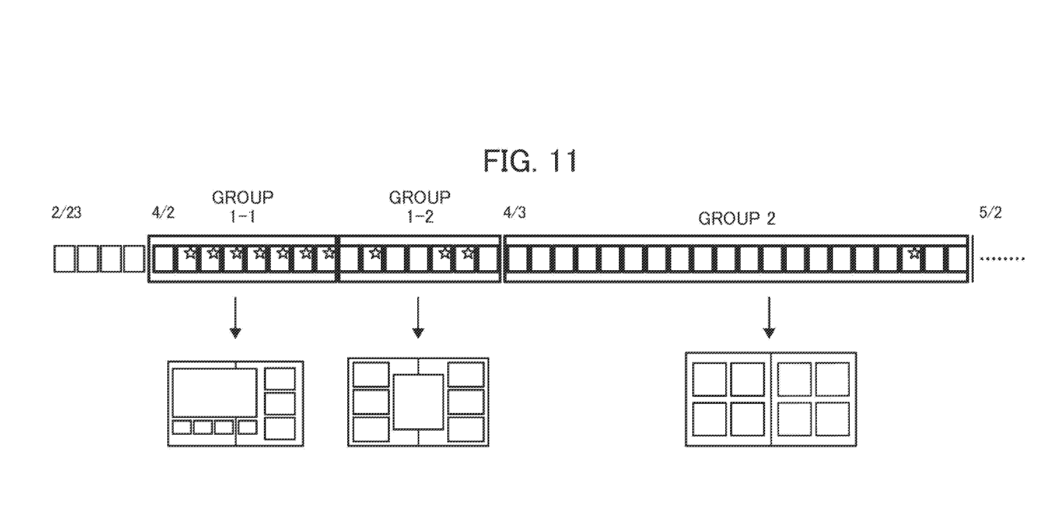

For example, in the example illustrated in FIG. 9, the re-grouping unit 60 divides 15 images in Group 1 which has the largest number of images having operation information added thereto into two groups, namely, Group 1-1 including 8 images and Group 1-2 including 7 images, as illustrated in FIG. 11.

Accordingly, the images of Group 1 having a high importance level are divided into two groups and all the images having operation information added thereto in the groups thus obtained are arranged in two pages of the photo book, respectively.

The reason for performing the re-dividing processing or the re-coupling processing in consideration of the images having operation information added thereto as described above is to prevent images having operation information added thereto from not being used in the layout of the photo book in the case where the number of images having operation information added thereto in a group is more than the maximum number of images to be arranged in one page of the photo book through the re-dividing or re-coupling of groups.

When the number of selected groups is equal to the number of pages of the photo book and the number of images having operation information added thereto in a group is equal to or less than the maximum number of images to be arranged in one page of the photo book, the re-grouping unit 60 needs neither to perform the re-dividing processing nor the re-coupling processing.

Subsequently, for each re-grouped group, the image selecting unit 62 selects a predetermined number of images out of plural images included in the relevant group on the basis of the operation information and the evaluation values.

For example, when the maximum number of images to be arranged in one page of the photo book is 8 and the number of images having operation information added thereto is 8, the image selecting unit 62 selects all the images having operation information added thereto.

When the number of images having operation information added thereto is in a range of 1 to 7, the image selecting unit 62 selects all the images having operation information added thereto and selects the other image or images out of the images not having operation information added thereto in the group on the basis of their evaluation values determined by the image analyzing unit 54 until the total number of images reaches the maximum number of images to be arranged in one page of the photo book.

When there is no image having operation information added thereto in the relevant group, the image selecting unit 62 selects 8 images out of the images not having operation information added thereto in the group on the basis of their evaluation values determined by the image analyzing unit 54.

In the example illustrated in FIG. 11, all of 8 images of Group 1-1 are selected, all of 7 images of Group 1-2 are selected, and 8 images including one image having operation information added thereto are selected out of 20 images of Group 2.

Subsequently, the image arranging unit 64 arranges a predetermined number of selected images in a predetermined layout in corresponding pages of the photo book (that is to say, effects automatic layout) to create a synthetic image.

In the example illustrated in FIG. 11, the images selected from each group are arranged in two facing pages.

It is preferable that the image arranging unit 64 arranges the image selected from the images having operation information added thereto out of a predetermined number of selected images in a large area (with a large image size).

As described above, the synthetic image creating unit 30 selects a group including images having operation information added thereto out of plural groups, selects a predetermined number of images out of the images included in the selected group on the basis of the evaluation values and the operation information, and creates a synthetic image using the selected images.

That is, since the image processing server 16 creates a synthetic image such as a photo book or a collage print using the operation information including the added information such as “like” or “comment”, for example, it is possible to create a synthetic image having a higher degree of user satisfaction.

Here, it is preferable that the synthetic image creating unit 30 create a synthetic image according to a predetermined priority for creating the synthetic image.

The timings at which a synthetic image is created (updated) include, for example, the following timings 1 to 6.

1. When a new image is uploaded.

2. When images stored in an online album are edited.

3. At the time of ordering (when a synthetic image for confirmation of order is displayed).

4. At the time of backend processing.

5. When an image violating public order and morality is deleted.

6. When a real product is synthesized.

In this embodiment, the priority for creating a synthetic image is set to be the highest at timing 3 of ordering, and the priority is set to be sequentially lowered at timing 2 of editing images and timing 1 of uploading an image in this order. The priorities of timing 4 of backend processing, timing 5 of deleting an image violating public order and morality, and timing 6 of creating a real product are equal to each other and are set to be the lowest.

Here, timing 3 of ordering is set to the highest priority, because the user exhibits a clear intention of ordering a synthetic image such as a photo book or a collage print by clicking an ordering button using an input device such as a mouse.

Timing 2 of editing existing images is set to the second highest priority next to timing 3 of ordering, because the user exhibits an intention of updating and viewing a synthetic image using edited images by clicking the synthetic image update button.

On the other hand, timing 1 of uploading an image is set to a priority lower than that of timing 2 of editing existing images, because the user intentionally uploads the image but may not view the synthetic image.

Timing 4 of backend processing, timing 5 of deleting an image violating public order and morality, and timing 6 of creating a real product are not associated with the user's intention, and thus are set to a priority lower than that of timing 1 of uploading an image.

In this way, by creating a synthetic image such as a photo book or a collage print according to a predetermined priority, it is possible to reduce the time taken for the synthetic image to be presented to a user.

Timings 1 to 6 exemplify the timing of creating a synthetic image, but a synthetic image may be created at other timings and the priority may be set depending thereon.

The priority for creating a synthetic image may be set on the basis of the previous operation history information of the user such as viewing history information of the synthetic image or ordering history information of the synthetic image.

The ordering history information may be accumulated in the image managing server 14 even when the ordering is not fixed such as when a synthetic image for confirmation of order is created and displayed, as well as when the ordering is fixed.

For example, a user frequently viewing a synthetic image at the time of uploading an image is set to a higher priority, on the basis of the previous viewing history information of the user. On the other hand, a user not frequently viewing a synthetic image is set to a lower priority. In other words, a user whose viewing frequency of a synthetic image is equal to or greater than a predetermined frequency is set to a priority higher than that of a user whose viewing frequency of a synthetic image is less than the predetermined frequency.

Also, for example, a user having a high possibility of actually ordering a synthetic image is set to a higher priority, on the basis of the previous ordering history information of the user. On the other hand, a user having a low possibility of actually ordering a synthetic image is set to a lower priority. In other words, a user whose ordering frequency is equal to or greater than a predetermined frequency is set to a priority higher than that of a user whose ordering frequency is less than the predetermined frequency.

For example, when a user ordered a photo book including mainly scenery images in the past, an image group similarly including many scenery images is set to a higher priority. In other words, on the basis of the previous ordering history information of a user, images of the same theme as the images used for the synthetic image previously ordered by the user are set to a priority higher than that of images different in theme from the images used for the synthetic image previously ordered by the user.

The priority for creating a synthetic image may be set on the basis of editing details performed by the user on the existing images in the online album acquired.

With regard to the editing details, for example, when the number of images edited by a user is equal to or more than a predetermined number, the volume of change in the synthetic image is also large. Accordingly, it is estimated that the user wants to view and confirm the synthetic image changed, so that the priority is set to be higher than that when the number of images edited by the user is less than the predetermined number.

For example, assumed that the predetermined number is 10, the priority when the number of images edited by the user is equal to or more than 10 is set to be higher than that when the number of images edited by the user is less than 10.

Also, for example, when the volume of editing such as trimming or color correction performed by a user on images is equal to or more than a predetermined volume, the volume of change in the synthetic image is also large. Accordingly, it is estimated that the user wants to view and confirm the synthetic image changed, so that the priority is set to be higher.

On the other hand, when the volume of editing on images is less than the predetermined volume, for example, when only rotation of a single image is performed, the volume of change in the synthetic image is small. Accordingly, it is estimated that the possibility that the user expressly clicks the synthetic image update button to confirm the updated synthetic image is low, so that the priority is set to be lower.

When the number of images edited by the user is equal to or more than a predetermined number or when the volume of editing performed by the user on images is equal to or more than a predetermined volume, it is preferable that the synthetic image be created again before the user clicks the synthetic image update button with an input device such as a mouse.

In addition, the priority for creating a synthetic image may be set by determining whether or not an image is suitable for a synthetic image such as a photo book or a collage print on the basis of details of the image.

Images uploaded to a server of a cloud service include a lot of images not suitable for creating a synthetic image such as a photo book or a collage print. Accordingly, it is preferable that by setting the priority of images suitable for creating a synthetic image such as a photo book or a collage print to be higher, the images suitable for creating a synthetic image be preferentially used to create a synthetic image such as a photo book or a collage print.

Here, examples of the information for making a decision on whether or not an image is suitable for a synthetic image such as a photo book or a collage print include the image theme, the number of images, the image quality, the tag information (collateral information), the shooting period of time, the image size, the type of image shooting device, and the subject person (face).

Regarding the image theme, event (such as traveling, birthday party, and sports day), baby or child, and ceremony (such as wedding ceremony, school entrance ceremony, and graduation ceremony) are determined to be suitable for a synthetic image such as a photo book or a collage print.

Regarding the number of images, when the number of images included in the acquired online album is equal to or more than a predetermined number, for example, the recommended number of images, it is determined to be suitable for a synthetic image such as a photo book or a collage print.

Regarding the image quality, an image having a predetermined resolution or higher and having no blurring is determined to be an image suitable for a synthetic image such as a photo book or a collage print.

For example, the image theme can be determined on the basis of details of “comment” as added information of the image or the result of the image analysis in the image analyzing unit 54. The image quality can be determined on the basis of the image analysis.

The images which are determined to be suitable in theme, number and quality for a synthetic image such as a photo book or a collage print (that is to say, images highly likely to result in ordering) are set to a priority higher than that of other images.

The tag information such as shooting date and time information of Exif is automatically attached to an image captured by a digital still camera or a camera function of a mobile phone/smartphone, but is not attached to an image processed by a user or a scanned image. It is preferable that images having the tag information attached thereto, that is, the images captured by a digital still camera or a camera function of a mobile phone/smartphone, be preferentially used as such to create a synthetic image such as a photo book or a collage print. Therefore, the priority when the tag information is attached to an image is set to be higher than that when the tag information is not attached to an image.

In addition, it is preferable that images of which the shooting date and time is included in a predetermined shooting period of time out of images having the tag information such as the shooting date and time information attached thereto be preferentially used to create a photo book. Therefore, on the basis of the shooting date and time information included in the tag information, images of which the shooting date and time is included in a predetermined shooting period of time are set to a higher priority than that of images of which the shooting date and time is not included in the predetermined shooting period of time.

Here, examples of the images of which the shooting date and time is included in a predetermined shooting period of time include several hundreds of images of the same shooting date (such as daily snap images or images captured in an event such as sports day) and several hundreds of images captured in a period of several days to one week (such as images captured in an event such as traveling).

The range of the predetermined shooting period of time is not limited to one day or one week, but may be set to an arbitrary period of time.

For example, in the case where images are uploaded to a server by several thousands, if not less than a certain number of images with successive shooting dates, such as 34 images with a shooting date of Feb. 10, 2013, 25 images with a shooting date of Feb. 11, 2013, and 54 images with a shooting date of Feb. 12, 2013, are uploaded, the images can be thought to be an image group captured in an event such as traveling. Therefore, a synthetic image such as a photo book or a collage print is created using an image group including not less than a certain number of images captured at successive shooting dates.

In contrast, an image group captured in a long shooting period of time, which includes images with shooting dates of Oct. 22, 2009, Mar. 3, 2010 and Apr. 12, 2010, for instance, does not have a consistent shooting tendency, and it is thus not attractive to create a synthetic image such as a photo book or a collage print using such an image group.

Regarding the image size, an image size equal to or larger than a predetermined size is set to a higher priority than an image size less than the predetermined size, on the basis of the information on image size included in the tag information.

Regarding the type of image shooting device, the priority when the image shooting device is a digital still camera is set to be higher than that when the image shooting device is a mobile phone or a smartphone, on the basis of the information on type of image shooting device included in the tag information.

Regarding the subject person (face), the priority when the number of subject persons (faces) appearing in an image is equal to or more than a predetermined number is set to be higher than that when the number of subject persons appearing in an image is less than the predetermined number.

It is preferable that the setting of the priority depending on details of an image be applied to timing 1 of uploading an image and timing 2 of editing existing images.

The priority for creating a synthetic image may be set on the basis of the number of added information pieces such as “like” or “comment” added to each image by other users of the SNS.

That is, an image having a large number of added information pieces such as “like” or “comment” added thereto is determined to be an image important to the user, and the priority for creating a synthetic image of an online album including images of which the number of added information pieces is equal to or more than a predetermined number is set to be higher.

For example, it is preferable that the setting of the priority depending on the number of added information pieces be applied to timing 2 of editing existing images.

In addition, the priority for creating a synthetic image may be set on the basis of a user's login state in the cloud service such as the SNS or the online storage service.

For example, in the case where a user logs out after the user uploads an image and before a synthetic image is created, the synthetic image has only to be created until the user logs in later, and thus, the priority is set to be lower. In other words, a user in a login state after uploading an image is set to a priority higher than that of a user in a logout state before a synthetic image is created.

For example, in the case where an image is deleted for the reason of violating public order and morality, a user in a login state is set to a priority higher than that of a user in a logout state.

In the case where a user logs in after an image is deleted for the reason of violating public order and morality and before a synthetic image is re-created, the user is set to a priority higher than that of a user in a logout state.

For example, it is preferable that the setting of the priority depending on the login state be applied to timing 4 of backend processing.

The priority can be set to multiple steps such as two steps or three or more steps.

The synthetic image creating unit may change a synthetic image (product) to be created depending on the priority for creating a synthetic image.

For example, when the priority is set to be equal to or higher than a predetermined value, the synthetic image creating unit creates as a synthetic image a photo book with a larger number of pages and a larger page size than when the priority is set to be less than the predetermined value. When the priority is set to be less than a predetermined value, the synthetic image creating unit creates a photo book with a smaller number of pages and a smaller page size than when the priority is set to be equal to or higher than the predetermined value, or creates a synthetic image in the form of a single sheet such as a collage print.

While creation of a photo book is described as an example, the same is true of creation of a collage print. When a collage print is created, for example, collage prints corresponding in number to the groups selected by the group selecting unit 58 can be created and sequentially presented to a user. When a collage print is created, the re-grouping by the re-grouping unit 60 may be performed or may not be performed.

Finally, details of the image analyzing unit 54 will be described below.

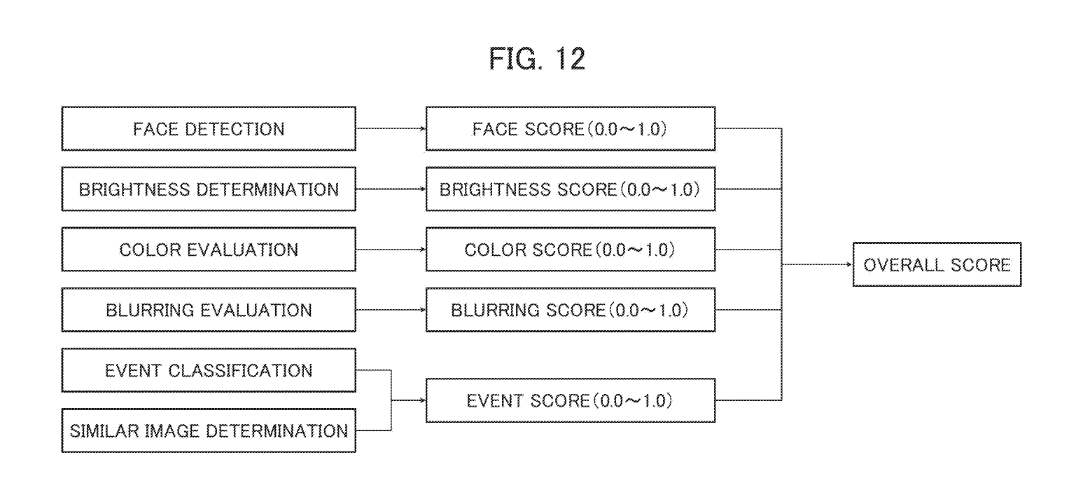

As shown in FIG. 12, the image analyzing unit 54 performs plural image analysis processings including, for example, a face detection processing, a brightness determination processing, a color evaluation processing, a blurring evaluation processing, an event classification processing, and a similar image determination processing.

The face detection processing is a processing of detecting the number of faces (face areas), the face size, the face orientation, the face position, and the like of persons included in an image.

For example, as a result of the face detection processing, the image analyzing unit 54 determines an image having a large number of faces therein, an image having a large face size, an image having a face directed to the front, an image in which a face is located at the center thereof, and the like to have a high importance level, and sets the face score as the evaluation value of the result of the face detection processing to be high.

The brightness determination processing is a processing of evaluating image brightness of, for example, an entire image or a predetermined area such as a face area detected in the face detection processing.

The image analyzing unit 54 determines the brightness of, for example, the face area detected in the face detection processing as the brightness determination processing, sets the brightness score as the evaluation value of the result of the brightness determination processing to 1.0 when the brightness of the face area is suitable, and sets the brightness score to be lower when the area is excessively bright or excessively dark.

Since, in the above-described method, only the brightness score of an image including a face can be determined, for example, the brightness score of an image including a face may be determined as described above and the brightness score of an image not including a face may be determined on the basis of the brightness determination result of the entire image.

The color evaluation processing is a processing of evaluating the color tone of, for example, the entire image or a predetermined area such as a face area.

The image analyzing unit 54 sets the color score as the evaluation value of the result of the color evaluation processing to be relatively high, for example, when the color of the image is vivid, and sets the color score to be relatively low when the image is in a dull color or is colorless. The color score is set to be relatively high with respect to the image of appropriate exposure, and set to be relatively low with respect to the image of under-exposure or over-exposure.

The blurring evaluation processing is a processing of evaluating a degree of blurring of an image.

As a result of the blurring evaluation processing, the image analyzing unit 54 sets the blurring score as the evaluation value of the result of the blurring evaluation processing to 1.0, for example, when there is no blurring, and sets the score to be lower depending on the degree of blurring.

The event classification processing is a processing of classifying (grouping) images on the basis of shooting date and time of the images for each event such as birthday party or sports day. The similar image determination processing is a processing of determining similar images out of plural images for each event or the like.

The image analyzing unit 54 determines an event with a large number of images, an event with a large number of detected faces, an event with a large number of similar images, and the like to be important events as a result of the event classification processing and the similar image determination processing, and sets the event score as the evaluation value of the result of the event classification processing and the similar image determination processing to be high.

The similar image determination processing is not limited to determination of similar images for each event, but may include determining similar images out of images included in an arbitrary group, such as images uploaded by one and the same user, and images simultaneously uploaded.

Since the above-mentioned image analysis processings are conventional and various known image analyzing methods can be used in the present invention, the detailed methods thereof will not be described herein. The image analyzing unit 54 may perform image analysis processing other than described above.

In the image analyzing section 54, the face score, the brightness score, the color score, the blurring score, and the event score are determined in a range of 0.0 to 1.0 on the basis of the results of the image analysis processings such as the face detection processing, the brightness determination processing, the color evaluation processing, the blurring evaluation processing, the event classification processing, and the similar image determination processing, and the overall score of the scores as a result of the image analysis processings is calculated.

The results obtained by multiplying the resultant scores of the image analysis processings by predetermined weights may be added to calculate the overall score. In this embodiment, the weight of the score as a result of the face detection processing is set to be the largest. That is, the face weighting coefficient is set to 1.00, the brightness weighting coefficient is set to 0.05, the color weighting coefficient is set to 0.10, the blurring weighting coefficient is set to 0.05, and the event weighting coefficient is set to 0.20. The overall score is calculated using Equation (1).

Overall score=face score*face weighting coefficient+brightness score*brightness weighting coefficient+color score*color weighting coefficient+blurring score*blurring weighting coefficient+event score*event weighting coefficient (1)

The basic description of the present invention has been made above.

While the present invention has been described in detail, the present invention is not limited to the above-mentioned embodiments, but may be improved or modified in various forms without departing from the gist of the present invention.

What is claimed is:

1. An image processing apparatus that creates a synthetic image using a plurality of images stored in an image managing server, comprising:
an image acquiring unit that acquires a plurality of images from the image managing server; and
a synthetic image creating unit that creates the synthetic image using the acquired images according to a predetermined priority for creating the synthetic image.

2. The image processing apparatus according to claim 1,
wherein the priority is predetermined based on users' operation history information which includes viewing history information of the synthetic image and ordering history information on the synthetic image.

3. The image processing apparatus according to claim 2,
wherein the priority is set to be higher for a user of whom a viewing frequency of the synthetic image is equal to or greater than a predetermined frequency than for a user of whom the viewing frequency is less than the predetermined frequency, based on the viewing history information.

4. The image processing apparatus according to claim 2,
wherein the priority is set to be higher for a user of whom an ordering frequency is equal to or greater than a predetermined frequency than for a user of whom the ordering frequency is less than the predetermined frequency, based on the ordering history information.

5. The image processing apparatus according to claim 2,
wherein the priority is set to be higher for an image identical in theme to images used for a synthetic image previously ordered by a user than for an image different in theme from the images used for the synthetic image previously ordered by the user, based on the ordering history information.

6. The image processing apparatus according to claim 1,
wherein the priority is predetermined based on editing details performed on the acquired images by a user.

7. The image processing apparatus according to claim 1,
wherein the priority is predetermined based on details of an image.

8. The image processing apparatus according to claim 7,
wherein the priority is set to be higher when a number of the acquired images is equal to or more than a predetermined number than when the number of the acquired images is less than the predetermined number.

9. The image processing apparatus according to claim 7,
wherein the priority is set to be higher for an image with a predetermined resolution and without blurring than for other images.

10. The image processing apparatus according to claim 7,
wherein the priority is set to be higher for an image having tag information added thereto than for an image not having the tag information added thereto.

11. The image processing apparatus according to claim 10,
wherein the priority is set to be higher for an image of which a shooting date and time is included in a predetermined shooting period than for an image of which the shooting date and time is not included in the predetermined shooting period, based on shooting date and time information included in the tag information.

12. The image processing apparatus according to claim 10,
wherein the priority is set to be higher for an image of which a size is equal to or larger than a predetermined size than for an image of which the size is smaller than the predetermined size, based on image size information included in the tag information.

13. The image processing apparatus according to claim 10,
wherein the priority is set to be higher when an image shooting device is a digital still camera than when the image shooting device is a mobile phone or a smartphone, based on information on type of image shooting device included in the tag information.

14. The image processing apparatus according to claim 7,
wherein the priority is set to be higher for an image in which a number of subject persons is equal to or more than a predetermined number than for an image in which the number of subject persons is less than the predetermined number.

15. The image processing apparatus according to claim 1,
wherein the priority is predetermined based on a number of added information pieces of at least one of favorite information and comment added to each image by other users.

16. The image processing apparatus according to claim 15,
wherein the priority is set to be higher when the number of the added information pieces is equal to or more than a predetermined number than when the number of the added information pieces is less than the predetermined number.

17. The image processing apparatus according to claim 1,
wherein the image managing server is adapted to provide a cloud service, and
the priority is predetermined based on a user's state of logging in the cloud service.

18. The image processing apparatus according to claim 17,
wherein the priority is set to be higher for a user who is in a login state after upload of images than for a user who has logged out before the synthetic image is created.

19. The image processing apparatus according to claim 1,
wherein the priority is set in two or more steps.

20. The image processing apparatus according to claim 1,
wherein the synthetic image is a photo book or a collage print, and
wherein when the priority is set to be equal to or higher than a predetermined value, the synthetic image creating unit creates a photo book having a larger number of pages and a larger page size as the synthetic image than when the priority is set to be lower than the predetermined value, and when the priority is set to be lower than the predetermined value, the synthetic image creating unit creates a photo book having a smaller number of pages and a smaller page size than when the priority is set to be equal to or higher than the predetermined value, or a collage print, as the synthetic image.

21. An image processing method of creating a synthetic image using a plurality of images stored in an image managing server, comprising the steps of:
acquiring a plurality of images from the image managing server; and
creating the synthetic image using the acquired images according to a predetermined priority for creating the synthetic image.

22. An image synthesizing system comprising:
an image managing server; and
the image processing apparatus according to claim 1 that creates a synthetic image using a plurality of images stored in the image managing server.
